(19) United States
(12) Patent Application Publication
(10) Pub. No.: US 2020/0010253 A1
(43) Pub. Date: Jan. 9, 2020

(54) Packaging Element

(71) Applicant: Constantia Teich GmbH, Weinburg (AT)

(72) Inventors: Karl Borsky, Wien (AT); Sarah Kienzle, Wien (AT); Helmut Resch, Rabenstein (AT)

(21) Appl. No.: 16/482,482

(22) PCT Filed: Dec. 29, 2017
(86) PCT No.: PCT/EP2017/084800

§ 371 Date: Jul. 31, 2019

(30) Foreign Application Priority Data
Feb. 21, 2017 (AT) A50141/2017

(51) Int. Cl. B65D 65/46; B32B 3/26; B32B 33/00; B65D 43/02; B65D 77/20

(52) U.S. Cl. CPC B65D 65/46; B32B 3/26; B32B 33/00; B65D 2543/00027; B65D 77/20; B32B 2435/02; B65D 43/02

(57) ABSTRACT

A planar packaging element for use in the production of an item of packaging. On at least one first surface of the packaging element a structure is arranged which reduces the susceptibility to adhesion. The structure consists of a material which can be removed in a removal step of a method, and the removal step can be applied to the finished item of packaging which may or may not be filled with a product.

### TECHNICAL FIELD

The present teaching relates to a planar packaging element for use in the production of an item of packaging, wherein, on at least one first surface of said packaging element a structure is arranged which reduces susceptibility to adhesion, and a method for the production of a planar packaging element for use in the production of an item of packaging, wherein on at least one first surface of said packaging element a structure is arranged which reduces susceptibility to adhesion. Furthermore, the present teaching relates to an item of packaging having a packaging element and a method for producing an item of packaging.

### BACKGROUND

Planar packaging materials, in particular sealing films or other lidding films, as well as labels, can be fed piecewise as blanks in a stacked form to a processing machine, wherein the processing machine must separate the blanks before use. This is the case, for example, with adjacent sealable film closure lids for containers, commonly referred to as sealing films. The separation can result in a so-called “glass pane effect,” wherein two adjacent blanks adhere to each other and thus two or more blanks are fed simultaneously to the processing machine. This leads to the production of rejects and can also affect the processing machine and cause downtimes and repair costs.

In order to prevent the glass pane effect, it is known to provide one side of the material with a structured surface. This can be done, for example, by introducing an embossing pattern, such as disclosed in EP1866147 B1, or by applying a raised print pattern to produce a rough surface, as disclosed, for example, in EP1340694 A2.

Although these solutions facilitate the separation of the products considerably and accordingly improve the packaging process, the rough or structured surface can be perceived by the user as unpleasant. If, for example, yoghurt adheres to the inside of a yoghurt cup lid, many users like to lick it after opening, whereby the smoothest possible surface is perceived as pleasant and hygienic. Users who are accustomed to this might suspect a product defect in a rough surface even though the product itself is flawless. Even on the “pretty” side, which is visible from the outside and constitutes the visible surface, such a pattern can be distracting.

### SUMMARY

The object of the subject present teaching is to provide a novel packaging material, with which these and other disadvantages are overcome.

According to the present teaching, this object is achieved by a packaging element of the type mentioned, in which the structure consists of a material that is removable in a removal step of a method, wherein the removal step can be applied to the finished item of packaging which may or may not be filled with a product. As a result, packaging elements can be produced in which the advantages of the structure in production can be utilized. Thereafter, the structure can be removed by applying the removal step, so that it can no longer be perceived by the customer nor can it be perceived as disturbing.

Each sequence of the method steps executable on the item of packaging and which results in a removal of the structure without significantly affecting the product and/or the packaging is referred to in the context of the present invention as a “procedural removal step” (hereinafter also referred to simply as “removal step”). In particular, the removal step may comprise dissolving the structure with a solvent, in particular with water (hot or cold) and/or water vapor, but the term is not limited thereto.

The structure is adapted to the respective product and the respective production method, wherein the removal step is advantageously applicable during the production of the packaging and/or during a processing and/or storage process downstream of this production.

Depending on the application, an inner surface facing the product, or an outer surface facing away from the product, may be referred to as a “first surface,” depending on where the structure is applied. Optionally, both inner and outer surfaces may be provided with the structure.

In an advantageous embodiment of the present teaching, the structure may consist of a material that is removable by the removal step, in particular a dissolvable, softenable and/or degradable material.

In a further advantageous embodiment, the structure can be dissolvable in the product. The amount and type of material of the structure are adapted to the product in such a way that the product quality is not affected. Where appropriate, the formulation of the product may also be tailored to the subsequent incorporation of the material of the structure.

Advantageously, the structure may be applied to the first surface by means of a printing process. This makes it possible to implement a simple production method which can be carried out with conventional systems. The application can be made over the entire surface or in a pattern. In the former case, for example, the structure may produce a defined roughness on the surface, which reduces susceptibility to adhesion; in the second case the pattern, for example a regular array of slightly raised structure points, may act as a spacer, preventing a glass pane effect and thereby reducing susceptibility to adhesion. The pattern may have, for example, a regular or irregular arrangement of points, geometric figures and/or logos. Matching the pattern to an underlying print image is generally not required because the pattern is removed before the customer sees it. Nevertheless, a special printed image, for example, as an indication of origin may be useful. For example, it may be advantageous if the pattern cannot or should not be removed within protected regions, such as the seal regions, so that it is also recognizable to the customer there as well.

In a preferred embodiment, the material of the structure may be food safe, which allows the use of the present teaching in the food and animal feed sector.

According to the present teaching, the structure may advantageously comprise one or more materials selected from a rubber coating, for example in the form of a water-soluble polymer, starch, in particular potato starch, wheat starch, rice starch or corn starch, gelatin, sugar, salt, in particular table salt, polyvinyl alcohol (PVOH), wax, in particular beeswax or carnauba wax, or mixtures of these materials. The materials may be processed for purposes of application in a liquid state and then dried, wherein appropriate solvents, especially water, may be used. Moreover, while being fully aware of the teachings herein, those skilled in the art will readily be able to recognize and select materials other than those enumerated above that are suitable for producing the structure.

Preferably, the structure may contain at least predominantly one of these materials. The term “at least predominantly” in the context of the present disclosure includes substances which contain the respective material in a volume and/or weight proportion which exceeds the volume or weight proportion of any other material in the substance.

Optionally, further fillers may be added to the material of the structure. The fillers are added, for example, to another material called a binder, wherein the (weight) proportion of the fillers may in some cases also exceed the proportion of the binder, as long as the function of removability is maintained.

Generally, materials may be used which remain in a stable or solid form under the storage conditions and processing conditions common to packaging elements and are removable by a change in environmental conditions such as softening, dissolution, degradation, decomposition and/or volatilization. As ambient conditions, in particular a temperature or a temperature curve, a humidity, a pressure, an action of chemical agents, for example of solvents or vapor, or a specific sequence of such environmental conditions may be considered.

The external environment of the finished product (for example, a moist environment and an elevated temperature during a processing step or a storage temperature and storage conditions during storage) and/or the immediate environment of the structure (for example, also the conditions within a package) may be considered as “environment.” Through a specific selection of the material used for the structure, this can be adapted to an existing production process such that the removal step is implemented solely on the basis of the process steps and/or processes already provided during product processing or packaging and/or during other processes.

Advantageously, the removal step may include the action of a defined temperature over a defined period of time, which allows a particularly simple and easily parameterizable processing of the packaging elements, for example by storage of a fully filled and sealed packaging under specific conditions.

In a further advantageous embodiment, the removal step may comprise a sterilization step or a pasteurization step, in some cases followed by storage. Such method steps are provided for many products anyway, so that the structure is removed in the course of the normal manufacturing or filling process without the need to adapt the conventional processing process. As a result, the property of the “self-dissolving” structure is defined solely by the packaging element (or structure) itself, and the user (this is the manufacturer or filler of the product) merely has to use the packaging element according to the present teaching in the usual way with conventional products. An adaptation of the manufacturing process is hardly or not at all necessary for the user.

In an advantageous manner, the packaging element can be a lid, in particular a sealing film, which can be sealed onto a container, because in this technical field the disadvantages eliminated in accordance with the present teaching are particularly relevant to practice.

In another embodiment, the packaging element may be a label attachable to a container. The structure on the label can be removed before delivery to the customer, but in this case it is also possible to leave the structure as a tactile and/or visible design element on the label, and the structure can be removed only in the course of recycling of the bottle (or its refilling, for example, of returnable bottles). Normal inks, most of which contain mineral oils, cannot be removed from the label after printing on the label and can cause problems in recycling. These problems can be avoided according to the present teaching by removing the structure at the beginning of the recycling or cleaning process. When selecting the materials used for the structure, care must be taken to ensure that the structure does not dissolve during normal use by the user, for example by using waxes.

The object of the present teaching is further achieved by a method of the type mentioned above for producing a planar packaging element, wherein a material that is removable in a removal step is used for the structure and wherein the removal step can be applied to the finished packaging and may or may not be filled with a product.

The aforementioned method for producing a packaging is characterized by the following steps: Providing a planar packaging element according to the present teaching; providing a container and filling the container with a product; producing the packaging by sealing the container using the packaging element and applying a removal step of a method to remove the structure provided on the planar packaging element. This method uses the advantageous processability (in particular the separability) of the packaging element according to the present teaching, wherein these features are no longer noticeably detrimental to the customer.

Advantageously, the removal step may include the action of a defined environmental condition, in particular a defined temperature and/or a defined humidity over a defined period of time, so that the removal step can be easily integrated into existing production processes.

In an advantageous embodiment of the present teaching, the removal step may comprise a sterilization step or a pasteurization step, in some cases followed by storage. As a result, process steps can be used that are already provided in the production process of numerous products anyway.

In a further advantageous embodiment, the removal step may comprise contacting the structure with the product. The structure may dissolve in the product, for example.

### BRIEF DESCRIPTION OF THE DRAWINGS

The present teaching is described in greater detail in the following with reference to FIGS. 1 to 3, which show exemplary, schematic and non-limiting advantageous embodiments of the present teaching. In the drawings:

FIG. 1 shows a plan view of a packaging element according to the present teaching,

FIG. 2 shows a schematic representation of a method according to the present teaching for producing an item of packaging,

FIG. 3 is a schematic sectional view of an exemplary packaging element according to the present teachings and

FIG. 4 shows a further embodiment of a structure of a packaging element according to the present teachings that reduces susceptibility to adhesion.

### DETAILED DESCRIPTION

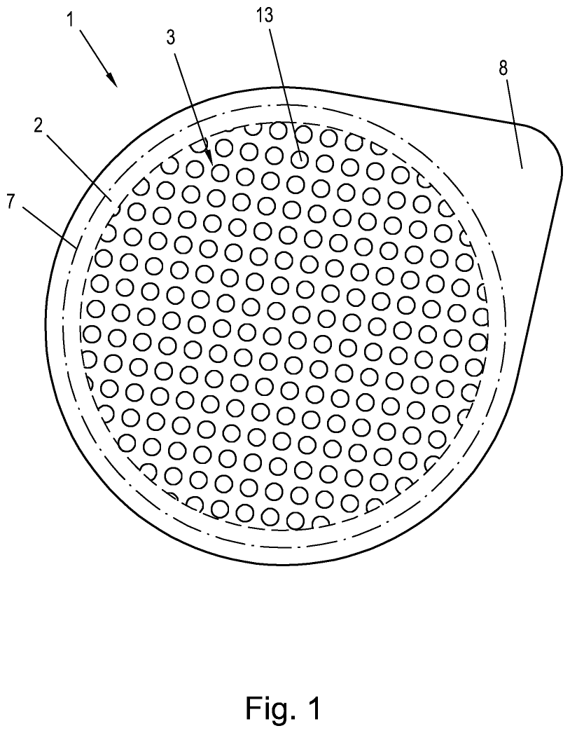

FIG. 1 shows in a plan view a packaging element 1, which is in the form of a known sealing film, such as is used for closing yogurt cups. Sealing films of this type are used in particular for yoghurt and dairy products, but also for many other items of packaging of products in the food and non-food sector, for example for pet food, wherein numerous forms adapted to the type of the respective container are known.

The packaging element 1 has a surface 2 on which a structure 3 is applied. The structure 3 in the illustrated case has a plurality of structure elements 13. The surface 2 may be either the outer surface facing away from the product or the inner surface facing the product. The structure elements 13 are each punctiform and raised and they are applied in a regular pattern on the surface 2. However, the structure 3 may also be formed by any other suitable pattern. For example, the structure 3 may be formed as a planar coating by a material that increases the roughness. The defined roughness avoids a glass pane effect and thus a sticking together of packaging elements 1 during the separation. The roughness can be influenced, for example, by fillers having a defined grain size or grain size distribution. The fillers may be dissolved in a binder, so that the material of the structure can be processed and applied in liquid form, for example by a conventional printing process, wherein the material is dried after application. The structure is generally applied to a film web from which the packaging elements 1 are then punched out.

By means of the structure, the packaging element 1 can easily be separated by machine when a plurality of packaging elements 1 are fed in a stacked form to a processing machine.

The packaging element 1 can be sealed in a known manner on a container in the region of a circumferential sealing seam 7, wherein an opening tab 8 projects, making it easier for the user to open it.

The packaging elements 1 can be made, for example, from a coated or uncoated aluminum foil, from a plastic-aluminum composite, a plastic foil, a plastic composite, from a paper plastic, a paper-plastic-aluminum composite or any other material that is known in the art or usable. When using paper, be careful not to damage the paper layer(s) during the removal step, such as by using special paper materials or by coating the paper. As special papers, for example, papers can be used which are not affected by the removal step due to their special properties. An example of such papers are parchment replacement papers (also referred to as “greaseproof paper” in English), which, in addition to particular barrier properties, have increased resistance to liquids and grease.

The packaging element 1 can be fully or partially printed on each of its surfaces and/or can have a full or partial print layer and/or reverse print layer in intermediate layers.

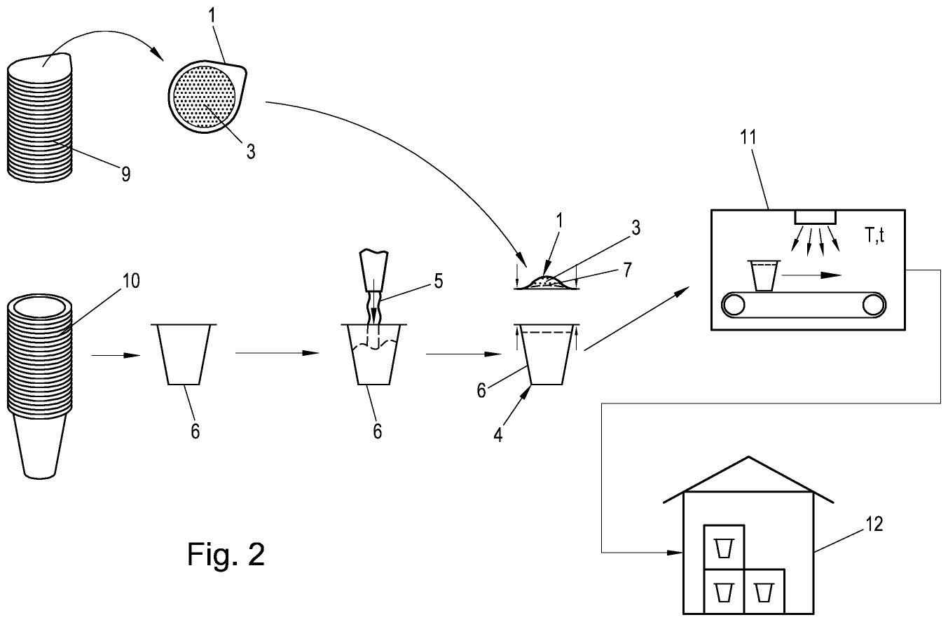

FIG. 2 shows the production of an item of packaging 4 according to the present teaching on the basis of a schematic flow diagram.

The item of packaging 4 consists essentially of a container 6, which receives the product 5, and the packaging element 1, which is sealed as a sealing film or lid on the edge of the opening of the container 6 and seals the container tightly.

The packaging element 1 is supplied for example in the form of a sealing film stack 9 and the container 6 is supplied in the form of a container stack 10 and fed to a filling device. Corresponding filling devices are known in the art in numerous embodiments and for the sake of clarity are therefore not shown in FIG. 2. The filling devices each have devices for separating the containers 6 and the packaging elements 1 (these separating devices are also known and therefore not shown in FIG. 2). The separation of the packaging elements 1 from the sealing film stack 9 is simplified and ensured by the structures 3.

After filling the container 6 with the product 5, the separated packaging element 1 is applied to the edge of the container 6 and sealed along the sealing seam 7, wherein the structure 3 can be located on the side facing the product 5 or the sealing side of the packaging element 1, or on the side facing away from the product, or the inside of the packaging element 1. In FIG. 2, the packaging element 1 shown above the container 6 is shown with a slightly upwardly bent, raised side, so that the structure can be seen.

After the package 4 is filled and sealed, it is preserved by pasteurization together with the product 5, for example in a pasteurization tunnel 11. The preservation takes place by setting a defined temperature T over a defined period of time t under defined environmental conditions. Depending on the product, another form of preservation may be carried out, for example by sterilization or by the action of chemical products, such as solvents.

During preservation, the structure 3 dissolves, wherein the dissolved material mixes with the product 5 and is absorbed and/or dissolved therein. In some cases, the inside of the packaging element 1 may be selectively brought into contact with the product 5 (for example by pivoting the packaging) in order to achieve dissolution of the structure 3 in the product.

The finished packaged and pasteurized product is then stored in a warehouse 12 under defined environmental conditions, wherein also the ambient conditions during storage can favor or cause a complete removal of the structure 3.

Materials which can be removed by removal steps which can be applied to the finished packaging 4, which may or may not be filled with a product 5, include, in particular, substances which dissolve and/or detach in a solvent, in particular water or water vapor. Another group of materials includes substances which soften or melt by the action of heat, wherein a combination of these effects can also occur.

For example, the structure 3 may be a rubber coating, such as that offered by Henkel AG under the product name Aquence GA 8161-22. Rubber coatings are industrially usable, easy to process, water-soluble and non-toxic. In particular, the very good water solubility of rubber coatings may be used to advantage.

The structure 3 may further have salts, in particular table salt. For example, structure elements 13 can be applied with a salt solution consisting of 50% by weight of water and 50% by weight of salt and then dried.

The structure 3 may also have sugar. For example, structure elements 13 can be applied with a sugar solution consisting of 50% by weight of water and 50% by weight of sugar and then dried. This corresponds to a substantially saturated sugar solution.

Furthermore, starch-containing materials can be used as the material for the structure 3, for example materials based on potato starch, wheat starch, rice starch or corn starch. Starch-containing materials may be, for example, starch-based adhesives. For example, a usable potato-starch-based adhesive is offered by, for example, Henkel AG under the product name Tobacoll TO 052-5502. Special advantages of starchy materials are, in addition to their good solubility in water, food safety and good environmental compatibility.

Also, gelatin-based materials can be advantageously used to form the structure 3. One of the advantages of gelatin is that the viscosity can be controlled by temperature, which makes the application process easier. Industrial gelatin is commercially available, for example, from the company Fritz Häcker GmbH-Co. KG under the product name Gelmelt 054. Gelatin is soluble in water or steam can be liquefied by heat. Gelatins may also be produced in an environmentally friendly and food-safe way.

Furthermore, materials based on polyvinyl alcohols (PVOH) may be used. PVOH is a thermoplastic which is known in particular for its use as an oxygen barrier and its advantageous composting properties. PVOH is water-soluble and has excellent film-forming, emulsifying and adhesive properties. In addition, PVOH is resistant to oil, grease and other solvents.

Another group of materials which may be used for the structure 3 are waxes, wherein particular preference is given to food-safe waxes, such as carnauba wax or beeswax. Waxes can be softened and removed by heat, for example, but offer good resistance to water.

Optionally, mixtures of the above materials may also be used and/or several of these or other materials may be used in combination to advantageously combine the respective particular properties. Also, materials may be provided with fillers.

Usable as fillers are, for example, chalk, talc, silicates, silica or similar substances. On the one hand, the fillers can be used to affect the height of the structure 3 or the structure elements 13 or a full-surface structure layer 19, and on the other hand they can improve the action of solvents, in particular water or water vapor, by affecting the surface of the respective structure 3. Fillers also make it possible to affect the roughness of the surface, as is advantageously used, for example, in connection with the exemplary embodiment described below in FIG. 4. Depending on the application, the proportion of the filler may be between 0% and 200% by weight (based on the proportion of the particular binder).

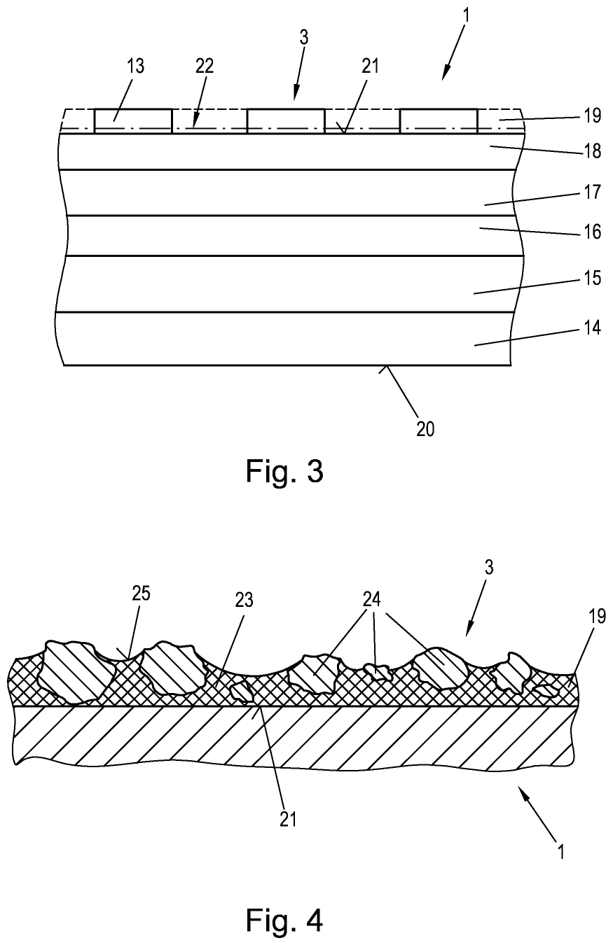

FIG. 3 shows a schematic and not-to-scale illustration of the layers of an exemplary packaging element 1 in a sectional view. The packaging element 1 has a sealing layer 14, a barrier layer 15, a primer layer 16, a print layer 17, an overcoat layer 18 and a structure layer 19. The free sealing surface 20 formed by the sealing layer 14 represents the side facing the product. In the case illustrated in FIG. 3, the structure 3 which reduces susceptibility to adhesion is thus formed by the structure layer 19, which is arranged on the “attractive side” or visible surface 21 of the packaging element 1 facing away from the product.

A packaging element 1 with such a layer structure can be used, for example, as a sealing film for sealing bowl containers, for example in the animal food area. Depending on the requirements, individual ones of the layer shown in FIG. 3 (for example, the primer layer 16 or the overcoat layer 18) may be omitted, if desired for the particular application. In essence, the packaging element may consist only of a single layer acting as a support to which the structure layer 19 is applied. Thus, all layers shown in FIG. 3 may be considered optional as long as a single or multi-layered layer is present which acts as a carrier layer. The subject disclosure includes all layer combinations that can be produced by omitting one or more of the layers shown in FIG. 3. Furthermore, the disclosure comprises layer constructions in which one or more of the layers shown in FIG. 3 themselves in turn have a multilayer structure.

The sealing layer 14 consists of a sealable material, for example based on a polyolefin, such as polyethylene or polypropylene, wherein the sealing layer preferably has a layer thickness in the range of 25-30 g/m². The sealing layer may, for example, also be formed as sealing wax, wherein the layer thickness is preferably designed according to the manufacturer's instructions. Typical amounts of material for sealing lacquers are, for example, in the range of about 2-10 g/m², preferably about 4 or 5 g/m².

The barrier layer 15 may be, for example, a barrier layer of aluminum with a layer thickness of, for example, between 6 μm and 100 μm. The respective layer thickness depends on the type of aluminum foil used and on the further layers, which in some cases are contained in the composite foil of the packaging element 1. For example, common aluminum foils (depending on the particular alloy and manufacturing process) have a tensile strength of between 60 N/mm² and 250 N/mm², so that the film thickness of the aluminum foil can be determined based on the desired tensile strength (and taking into account other parameters, such as required barrier properties) of the packaging element 1.

Alternatively, the barrier layer 15 may also consist of or comprise one or more plastic layers which achieve a desired barrier effect. The sealing layer 14 may, for example, be laminated onto the barrier layer 15 in a known manner or may be applied to the barrier layer in the coextrusion process.

The barrier layer 15 is followed by a primer layer 16, which improves the printability or the adhesion of a print layer 17 to the material of the barrier layer 15. The print layer 17 can be applied to the primer layer 16 or the barrier layer 15 by any desired printing method. In some cases, the packaging element 1 may also be unprinted. The print layer 17 is preferably coated with an overcoat layer 18, which protects the print layer 17 and improves its visual appearance.

Regardless of the type of printing and the layer sequence, a visual surface 21 is defined for each packaging element 1, wherein this is the surface that the customer sees as the outer surface of the packaging element 1 (and thus of the product). In FIG. 3, this visible surface 21 is formed by the outer surface of the overcoat layer 18. Optionally, the visible surface 21 of the packaging element 1 can be improved by additional methods, for example by a paint application of a wetting agent or by a corona treatment 22, as indicated by the dotted line. As further surface treatments, flame treatment, silicatization or titanization, for example, may be applied to surfaces of individual layers to improve optical quality and/or adhesiveness and/or other features. The additional method may be applied before or after the application of the structure layer 19. Since the structure layer 19 is removed before the consumer gets to see the product, it is preferable to use a surface treatment that occurs before the structure layer 19 is applied.

On the visible surface 21, the structure layer 19 is applied which is formed in FIG. 3 by a plurality of structure elements 13 applied in a pattern on the visible surface 21. For the application of the structure elements 13, any suitable method can be used, wherein on a large scale printing methods in particular are suitable, such as gravure, flexographic, UV flexographic, etc. Also, a full-surface application of a structure layer 19, as described for instance in FIG. 4 by way of example, can be produced by these methods. After application, the film material can be dried, for example, in a drying channel (by means of hot air), by drum drying, by means of an infrared radiator or a combination of these and in some cases further drying measures.

Depending on the nature of the structure elements 13, these may have a layer thickness of between about 1 μm and about 100 μm, preferably the layer thickness of the structure elements is in the range between about 20 μm and about 40 μm. The layer thickness can be adjusted by the type of application and by material parameters, for example the viscosity.

Instead of the construction shown in FIG. 3 and described above, the packaging material 1 can be made up of any suitable printed or unprinted film material which is provided with a corresponding structure 3 on at least one surface (or also on both surfaces). Examples of such base materials are films of aluminum, plastics, paper and laminating combinations of these materials. In order to protect paper layers against the action of the removal step, for example, they can be laminated between two water-impermeable layers of material and/or provided with another protective coating (for example, lacquer). In some cases, the paper may also contain the resistance-increasing additives. Depending on the intended use, in particular paper with a layer thickness of between about 15 g/m² and about 150 g/m², preferably between 20 g/m² and 70 g/m², can be used.

In particular, layers of polyolefins, such as polypropylene and polyethylene, polyamides, polyesters, such as polyethylene terephthalate, can be used as the plastics in the layer composite. Depending on the manner of the layer combination, the plastic layers may have layer thicknesses in the range of between about 5 μm and about 150 μm, wherein layer thicknesses in the range between 7 μm and 40 μm are preferred.

Aluminum foils may preferably be used in layer thicknesses between 6 μm and 100 μm.

Aluminum and some plastics may also be used as monofilms. The monofilm acts as a carrier material, wherein wetting agents can be applied to the surface in order to improve the adhesion or the print quality of the structure 3 which reduces susceptibility to adhesion. Optionally, a sealability on one or both surfaces may be achieved by applying a sealing lacquer, a COEX coating or a laminated sealing film. The structure 3 which reduces susceptibility to adhesion may be disposed on either the sealing side or the opposite side.

The aforementioned values for the layer thicknesses are merely indicative, wherein the individual layer thicknesses in a multi-layer composite are generally able to be in the lower bandwidth range or even lower. In contrast, for materials having only a few different layers, higher values for the individual layer thicknesses are to be expected, which may also exceed the stated values. However, the present teaching is not limited to specific layer thicknesses.

FIG. 4 shows a further embodiment in which the structure layer 19 is a layer applied over the entire area (or in some cases a partial area) consisting of a binder 23 in which a granular filler 24 is contained. The granular filler 24 is embedded in the structure layer 19 in the binder 23 so as to form a rough outer surface 25 serving as a structure 3 which reduces susceptibility to adhesion.

All binders described above in conjunction with the description of the materials suitable for the structure 3 can be used as the binder 23.

As a granular filler 24, for example, chalk, talc, silicates, silica or similar substances in a proportion between 0% and 200 wt.-% (based on the proportion of the respective binder) can be used. The grain size or grain size distribution of the filler can be determined depending on the desired surface roughness, the binder used and the application method used. Those skilled in the art, having the benefit of the disclosure set forth herein, will be able to set a desired surface roughness by well-directed selection of the above parameters through routine work and experimentation.

In sterilizing the finished packaged product provided with the packaging element 1, the binder 23 dissolves and is removed from the packaging element 1 together with the granular filler 24, so that the visible surface 21 forms the outermost and customer-visible surface of the packaging element 1.

In some cases, the removal action may also include mechanical steps, such as removing remnants of the structure 3 remaining on the visible surface 21 after a treatment step, such as by brushing with a brush, by blowing or aspirating, by washing or in a similar way.

For example, animal food containers are sterilized after filling and sealing, wherein the sterilization is carried out, for example, under steam and in some cases pressure at about 130° C. for a period of, for example, 30 minutes. The structure 3 is detached and dissolved during the sterilization by the action of the water vapor and removed.

Instead of the visible surface 21, the structure layer 19 may also be arranged on the side of the sealing surface 20. This is possible both in the embodiment with structure elements 13, as well as in the embodiment with binder 23 and filler 24. In both cases, the structure layer 19 may either extend over the entire surface of the sealing surface 21, or it may be applied only in areas on the sealing surface 21 which are outside of the areas to be sealed. In the former case, it must be ensured that the structure layer 19 does not affect the sealability of the sealing layer 14, or does so only insignificantly, which can be determined by routine tests.

In cases where the structure element 13 is disposed on the product-facing surface, the structure elements 13 facing the product (or the binder and in some cases the fillers 24) after packaging of the product dissolve away from the sealing surface 20 and mix with the product or dissolve in it, so that the user when the packaging element 1 is dissolved finds a smooth and flawless sealing surface 20.

The prerequisite for this, of course, is that a material (or a combination of materials) is chosen for the structure layer 19 that does not qualitatively influence the product in the relevant amount, influences it only insignificantly, or influences it positively or in a desired manner. For example, many dairy products, such as yoghurt products, and especially diet yoghurts, contain sugars and, in some cases, larger amounts of gelatin. For the use of the packaging element 1 as a sealing film for these products, a structured layer 19 arranged on the sealing surface 20 and made on the basis of sugar and/or gelatin, for example, would be suitable. For saline products, such as canned fish or fish products packaged in plastic trays, saline structure layers 19 may be used, wherein the salt dissolves in the moist environment of the product.

In order to be able to estimate the production capability and the properties of the embodiment shown in FIG. 4, a series of experiments was carried out by the applicant which is described below.

In the experimental series, several structure layers were produced by the applicant using the blends shown in Table 1.

TABLE 1

| Base | | | | | |
|---|---|---|---|---|---|
| material | Product | Control | Mixture 1 | Mixture 2 | Mixture 3 |
| potato | Tobacoll | 83.28% by | 73.28% by | 63.28% by | 53.28% by |
| starch | VP 052-5502 | weight | weight | weight | weight |
| solvent | water, | 16.72% by | 16.72% by | 16.72% by | 16.72% by |
| | demineralized | weight | weight | weight | weight |
| filler | Gasil EBN | — | 10.00% by | 20.00% by | 30.00% by |
| | | | weight | weight | weight |

The coating material used was a commercial potato-starch-based adhesive (Tobacoll TO 052-5502) blended with demineralized water in accordance with the mixing ratios summarized in Table 1. Different amounts of granular filler were added to this base stock. Synthetic amorphous silica was used as the filler, wherein the commercially available product GASIL® EBN sold by PQ Corporation, Cheshire, England was used. According to the manufacturer specifications, the filler material has an average grain size of 8.3 μm.

On the dull side of a strip of aluminum foil (with a thickness of 36 μm as a carrier material), the control or one of the three mixtures in the liquid state were applied extensively with a layer thickness of about 2 g/m² in each case and dried.

The properties of the samples were evaluated by optical (visual inspection) and haptic (by running a finger across) examination, respectively.

Both the surfaces provided with the control and those provided with blends 1 to 3 had a duller appearance compared to the uncoated surface of the aluminum foil. A difference between the different coated surfaces was not visible to the naked eye.

The difference between the control-coated surface and the uncoated aluminum surface was not haptically noticeable or hardly noticeable. On the other hand, the surfaces provided with the mixtures 1 to 3 exhibited a haptically clearly noticeable surface roughness, wherein only very slight differences in the perceived roughness are perceptible between the three surfaces. The difference in roughness of all mixtures compared to the control, however, was clearly perceptible.

All surface coatings described above could be easily and quickly removed by rinsing with water.

The present teaching described above is particularly (but not only) suitable for sealing films. Planar and piece-wise film materials which are used for sealing containers are referred to as sealing films. Sealing films usually have a sealing surface with which they are sealed to seal the container on an edge of the container. Also planar closure elements that are applied in a different way to a container, that is for example, by means of a clamp connection or by crimping the edge are considered in a broader sense as sealing films. The subject present teaching is not limited to film materials, but can also be used advantageously in connection with other planar packaging elements, for example for (in some cases coated) aluminum lids for cans. In general, the present teaching can be used for all planar packaging elements that must be separated before use. For example, the packaging element 1 according to the present teaching may also be a label, for example a bottle neck label.

The particular features of the specific embodiments described herein may be combined with one another by those skilled in the art in any meaningful manner to produce articles which, while not explicitly described herein, are within the scope of the present teaching.

1. A planar packaging element for use in the production of an item of packaging, wherein on at least one first surface of the packaging element a structure is arranged which reduces susceptibility to adhesion, wherein the structure is made of a material which can be removed in a removal step of a method, and the removal step can be applied to the finished packaging, which may or may not be filled with a product.

2. The packaging element according to claim 1, wherein the removal step can be applied during the production of the packaging and/or during a processing and/or storage process downstream of this production.

3. The packaging element according to claim 1, wherein the structure consists of a material removable by the removal step, in particular softenable and/or dissolvable and/or degradable material.

4. The packaging element according to claim 1, wherein the structure is dissolvable in the product.

5. The packaging element according to claim 1, wherein the structure is applied to the first surface by means of a printing process.

6. The packaging element according to claim 1, wherein the material of the structure is food safe.

7. The packaging element according to claim 1, wherein the structure includes one or more materials selected from a rubber coating.

8. The packaging element according to claim 1, wherein the removal step includes the action of a defined temperature over a defined period of time.

9. The packaging element according to claim 1, wherein the removal step includes a sterilizing step or a pasteurization step.

10. The packaging element according to claim 1, wherein the packaging element is a closure lid that can be sealed onto a container.

11. The packaging element according to claim 1, wherein the packaging element is a label that can be attached to a container.

12. An item of packaging comprising a packaging element according to claim 1.

13. A method for the production of a planar packaging element for use in the production of an item of packaging, wherein on at least one first surface of the packaging element a structure is applied which reduces susceptibility to adhesion, wherein a material which can be removed in a removal step of a method is used for the structure, and the removal step can be applied to the finished packaging, which may or may not be filled with a product.

14. A method for production of an item of packaging, wherein the method is characterized by the following steps:
providing a planar packaging element according to claim 1,
providing a container and filling the container with a product,
producing the item of packaging by sealing the container using the packaging element and
applying a removal step of a method for removing the structure provided on the planar packaging element.

15. The method according to claim 14, wherein the removal step includes the action of a defined environmental condition.

16. The method according to claim 14, wherein the removal step includes a sterilizing step or a pasteurization step.

17. The method according to claim 14, wherein the removal step includes bringing the structure into contact with the product.

18. The packaging element according to claim 1, wherein the structure includes one or more materials selected from a water-soluble polymer starch.

19. The packaging element according to claim 1, wherein the structure includes one or more materials selected from potato starch, wheat starch, rice starch or corn starch, gelatin, sugar, and salt.

20. The packaging element according to claim 1, wherein the structure includes one or more materials selected from table salt, polyvinyl alcohol (PVOH), wax, beeswax, or carnauba wax.

21. The method according to claim 14, wherein the removal step includes the action of:
a defined temperature and/or a defined humidity over a defined period of time.
